(19) United States
(12) Patent Application Publication
(10) Pub. No.: US 2026/0177890 A1
(43) Pub. Date: Jun. 25, 2026

(54) MULTI-CAMERA SUPPORT APPARATUS THAT EASILY ADJUSTS SPACING BETWEEN CAMERA MODULES

(71) Applicant: IDIS CO., LTD., Daejeon (KR)

(72) Inventors: Min Shic SHIN, Seongnam-si (KR); Jin Seong CHOI, Seongnam-si (KR)

(73) Assignee: IDIS CO., LTD., Daejeon (KR)

(21) Appl. No.: 19/284,773

(22) Filed: Jul. 30, 2025

(30) Foreign Application Priority Data
Dec. 20, 2024 (KR) 10-2024-0192218

(51) Int. Cl. G03B 17/56; F16M 11/10; F16M 11/20

(52) U.S. Cl. CPC G03B 17/561; F16M 11/10; F16M 11/2014; F16M 2200/08

(57) ABSTRACT

The present invention relates to a multi-camera support apparatus that easily adjusts spacing between camera modules and allows a plurality of camera modules to be implemented to revolve along concentric revolution paths to easily, simply, and finely adjust monitoring directions of the plurality of camera modules provided in a multi-camera.

### CROSS-REFERENCE TO RELATED APPLICATION(S)

This application claims priority from Korean Patent Application No. 10-2024-0192218, filed on Dec. 20, 2024 in the Korean Intellectual Property Office, the disclosure of which is incorporated herein by reference in its entirety.

### BACKGROUND

### 1. Field

The following description relates to a multi-camera in which a plurality of camera modules are mounted, and more particularly, to a multi-camera support apparatus that easily adjusts spacing between camera modules.

### 2. Description of Related Art

In a multi-camera, a plurality of camera modules are mounted in one housing to perform monitoring at 360 degrees. Even when only one multi-camera is installed in a wide area such as an airport or concert hall, the multi-camera can perform monitoring in all directions.

A plurality of camera modules are radially arranged in a multi-camera, and monitoring directions can be finely adjusted by adjusting spacing between the plurality of radially arranged camera modules.

The present inventor has studied on a multi-camera support apparatus with a structure improved such that a plurality of camera modules may revolve along concentric revolution paths to easily, simply, and finely adjust monitoring directions of the plurality of camera modules provided in a multi-camera.

### RELATED ART

### Patent Document

(Patent document 0001) Korean Patent Registration No. 10-2161912 (Published on Oct. 5, 2020)

### SUMMARY

The proposed invention is directed to providing a multi-camera support apparatus with a structure improved such that a plurality of camera modules are implemented to revolve along concentric revolution paths to easily, simply, and finely adjust monitoring directions of the plurality of camera modules provided in a multi-camera.

In one aspect of the present invention, a multi-camera support apparatus that easily adjusts spacing between camera modules includes a plurality of camera support brackets which support a plurality of camera modules to be tiltable and each includes a bracket body, camera module fixing parts which vertically extend upward from both sides of the bracket body and fix one of the camera modules to be tiltable, an inner revolution protrusion extending and protruding downward from an inner circumferential portion of the bracket body, and an outer revolution protrusion extending and protruding downward from a central portion of the bracket body, a circular camera support bracket mounting plate which includes an inner revolution path on which the inner revolution protrusion is seated and an outer revolution path on which the outer revolution protrusion is seated, wherein the plurality of camera support brackets are mounted to individually revolve along the inner revolution path and the outer revolution path, which are concentric paths, to allow spacing between the camera modules supported by the camera support brackets to be adjusted, a cylindrical inner guide which is vertically mounted at a central portion of the circular camera support bracket mounting plate and guides revolution while in close contact with and supporting the inner revolution protrusion of each of the plurality of camera support brackets, and a ring-shaped outer guide which is mounted on the outer revolution path and guides revolution while in contact with and supporting the outer revolution protrusion of each of the plurality of camera support brackets.

In accordance with an additional aspect of the present invention, the cylindrical inner guide may include a first restriction protrusion which protrudes along an outer circumferential portion of the cylindrical inner guide and is in close contact with and supports an upper portion of the inner revolution protrusion of each of the plurality of camera support brackets which are in close contact with and are supported by the outer circumferential portion to restrict the camera support brackets from being vertically separated.

In accordance with an additional aspect of the present invention, the multi-camera support apparatus that easily adjusts spacing between camera modules may further include an O-ring which is mounted on the inner revolution path and assists inner revolution of each of the camera support brackets under the inner revolution protrusion seated on the inner revolution path.

In accordance with an additional aspect of the present invention, the O-ring may adjust revolution sensitivity due to a change in amount of pressing through vertical spacing adjustment of the first restriction protrusion which is in close contact with and supports the upper portion of the inner revolution protrusion of each of the camera support brackets.

In accordance with an additional aspect of the present invention, the O-ring may be coated with urethan to improve the revolution sensitivity.

In accordance with an additional aspect of the present invention, the ring-shaped outer guide may include a second restriction protrusion which protrudes along an inner circumferential portion of the ring-shaped outer guide and is in close contact with and supports an upper portion of an outer circumferential portion of the outer revolution protrusion of each of the plurality of camera support brackets which are in contact with and are supported by the inner circumferential portion to restrict the camera support brackets from being vertically separated.

In accordance with an additional aspect of the present invention, the multi-camera support apparatus that easily adjusts spacing between camera modules may further include a plurality of tension balls which are mounted on the outer revolution path, assist outer revolution of each of the camera support brackets at both sides of the outer revolution protrusion seated on the outer revolution path, and provide an elastic force at the same time.

In accordance with an additional aspect of the present invention, the bracket body may include tension ball accommodation parts which are formed to be recessed in a bottom surface of the bracket body to be spaced apart from both sides of the outer revolution protrusion extending and protruding downward from the central portion and accommodate the tension balls.

### BRIEF DESCRIPTION OF THE DRAWINGS

FIG. 1 is a perspective view illustrating a configuration of a multi-camera support apparatus that easily adjusts spacing between camera modules according to one embodiment of the present invention.

FIG. 2 is a cross-sectional view illustrating the configuration of the multi-camera support apparatus that easily adjusts spacing between camera modules according to one embodiment of the present invention.

FIG. 3 is a side view illustrating a camera support bracket of the multi-camera support apparatus that easily adjusts spacing between camera modules according to one embodiment of the present invention.

FIG. 4 is a perspective view illustrating the camera support bracket that revolves on a circular camera support bracket mounting plate of the multi-camera support apparatus that easily adjusts spacing between camera modules according to one embodiment of the present invention.

FIG. 5 is a bottom perspective view illustrating the camera support bracket of the multi-camera support apparatus that easily adjusts spacing between camera modules according to one embodiment of the present invention.

FIG. 6 is a perspective view illustrating a dome cover of the multi-camera support apparatus that easily adjusts spacing between camera modules according to one embodiment of the present invention.

### DETAILED DESCRIPTION

The above-described and additional aspects of the present invention will be implemented through embodiments described with reference to the accompanying drawings. It is understood that components in the embodiments may be variously combined in one embodiment as long as there are no contradictory statements therebetween. Terms used in the present specification and claims should be interpreted as having meanings and concepts which are consistent with the described content or the technological scope of the present invention based on the principle that the inventors have appropriately defined concepts of the terms in order to describe the present invention in the best way.

Blocks described as “circuits” in the present specification may be provided as hardware components such as a dedicated semiconductor, a gate array, or a field programable gate array (FPGA), or a part thereof. One or a plurality of blocks may be implemented as one hardware component. As another example, such blocks may be implemented software-wisely in information processing devices in which calculation components execute program commands stored in memory components. A plurality of blocks may be implemented as some programs executed by the same calculation components.

As still another example, such blocks may also be implemented as a hybrid device in which some circuits are hardware components and the others are software components. In addition, in a software-wise implementation, a calculation component may include a digital signal processor, calculation dedicated processors, an artificial intelligence processing engine, an artificial intelligence dedicated processor, graphic processors, etc., or may be a combination thereof in a possible range.

Hereinafter, the present invention will be described in detail to facilitate understanding and reimplementing the present invention through exemplary embodiments described with reference to the accompanying drawings. Although specific embodiments are illustrated in the drawings and described in detail, this is not intended to limit embodiments of the present invention in the specific embodiments.

In the description of the invention, when it is determined that detailed descriptions of related well-known functions or configurations unnecessarily obscure the gist of the invention, the detailed descriptions thereof will be omitted.

It will be understood that when an element is referred to as being “connected” or “coupled” to another element, it can be directly connected or coupled to another element, or intervening elements may be present.

In contrast, it will be understood that when an element is referred to as being “directly connected” or “directly coupled” to another element, there are no intervening elements.

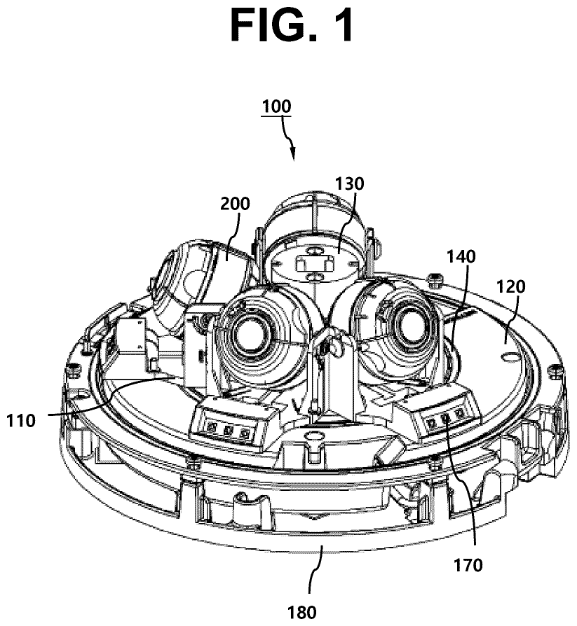

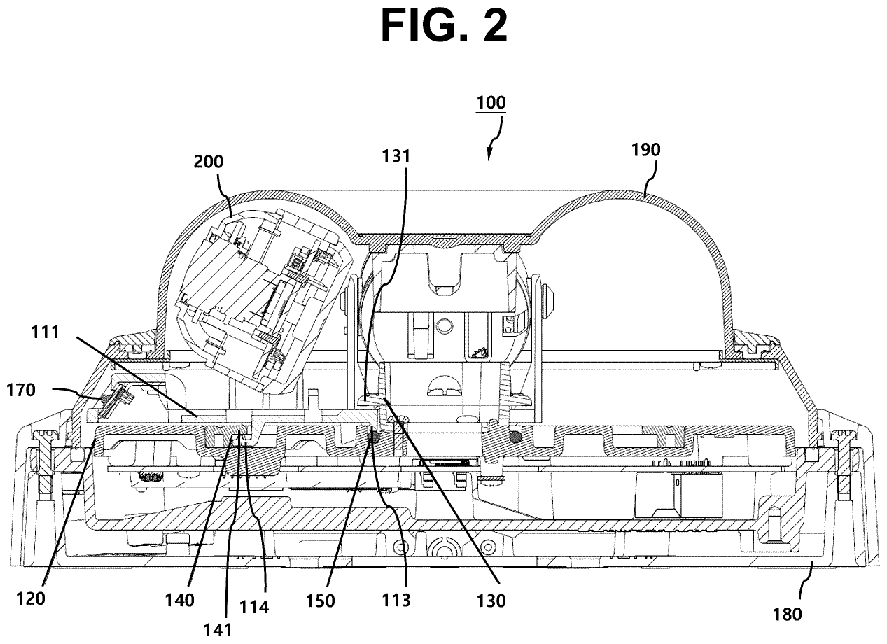

FIG. 1 is a perspective view illustrating a configuration of a multi-camera support apparatus that easily adjusts spacing between camera modules according to one embodiment of the present invention, and FIG. 2 is a cross-sectional view illustrating the configuration of the multi-camera support apparatus that easily adjusts spacing between camera modules according to one embodiment of the present invention.

As illustrated in FIGS. 1 and 2, the multi-camera support apparatus 100 that easily adjusts spacing between camera modules according to one embodiment includes a plurality of camera support brackets 110, a circular camera support bracket mounting plate 120, a cylindrical inner guide 130, and a ring-shaped outer guide 140.

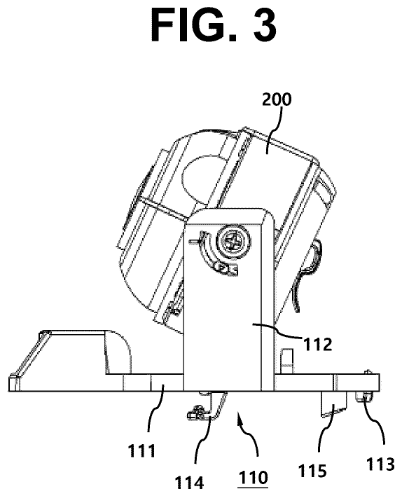

The plurality of camera support brackets 110 support a plurality of camera modules 200 to be tiltable. FIG. 3 is a side view illustrating a camera support bracket of the multi-camera support apparatus that easily adjusts spacing between camera modules according to one embodiment of the present invention.

As illustrated in FIG. 3, each of the camera support brackets 110 may include a bracket body 111, camera module fixing parts 112 which vertically extend upward from both sides of the bracket body 111 and fix one of the camera modules 200 to be tiltable, an inner revolution protrusion 113 extending and protruding downward from an inner circumferential portion of the bracket body 111, and an outer revolution protrusion 114 extending and protruding downward from a central portion of the bracket body 111.

In addition, the camera support bracket 110 may also be implemented such that an auxiliary revolution protrusion 115 disposed between the inner revolution protrusion 113 extending and protruding downward from the bracket body 111 and the outer revolution protrusion 114 further extends and protrudes downward from the bracket body 111.

The circular camera support bracket mounting plate 120 includes an inner revolution path 121 on which the inner revolution protrusion 113 is seated and an outer revolution path 122 on which the outer revolution protrusion 114 is seated, wherein the plurality of camera support brackets 110 are mounted to individually revolve along the inner revolution path 121 and the outer revolution path 122 that are concentric paths, and the circular camera support bracket mounting plate 120 allows spacing between the camera modules 200 supported by the camera support brackets 110 to be adjusted.

In addition, on the circular camera support bracket mounting plate 120, an auxiliary revolution path 123 on which the auxiliary revolution protrusion 115 is seated may be further formed between the inner revolution path 121 and the outer revolution path 122.

As the user manipulates such that the plurality of camera modules 200 mounted on the circular camera support bracket mounting plate 120 revolve along the inner revolution path 121, the outer revolution path 122, and the auxiliary revolution path 123 in desired monitoring directions, the monitoring directions of the plurality of camera modules provided in a multi-camera can be finely adjusted.

The cylindrical inner guide 130 is vertically mounted at a central portion of the circular camera support bracket mounting plate 120 and guides revolution while in close contact with and supporting the inner revolution protrusion 113 of each of the plurality of camera support brackets 110.

The ring-shaped outer guide 140 is mounted on the outer revolution path 122 and guides revolution while in close contact with and supporting the outer revolution protrusion 114 of each of the plurality of camera support brackets 110.

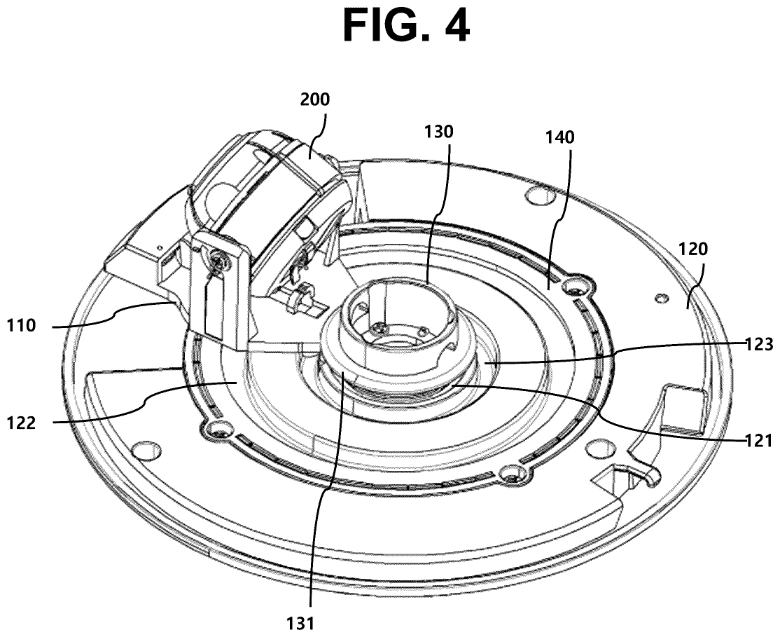

FIG. 4 is a perspective view illustrating the camera support bracket that revolves on the circular camera support bracket mounting plate of the multi-camera support apparatus that easily adjusts spacing between camera modules according to one embodiment of the present invention.

Referring to FIGS. 2 and 4, it can be seen that the inner revolution protrusion 113 is seated on the inner revolution path 121, the outer revolution protrusion 114 is seated on the outer revolution path 122, and the auxiliary revolution protrusion 115 is seated on the auxiliary revolution path 123. Accordingly, the camera support bracket 110 which supports the camera module 200 to be tiltable is implemented to revolve on the circular camera support bracket mounting plate 120 along the inner revolution path 121, the outer revolution path 122, and the auxiliary revolution path 123 which have the same center.

In this case, it can be seen that the cylindrical inner guide 130 is vertically mounted at a central portion of the circular camera support bracket mounting plate 120 and guides the revolution while in close contact with and supporting the inner revolution protrusion 113 of each of the plurality of camera support brackets 110, and the ring-shaped outer guide 140 is mounted on the outer revolution path 122 and guides the revolution while in close contact with and supporting the outer revolution protrusion 114 of each of the plurality of camera support brackets 110.

In the present invention with this implementation, since the plurality of camera modules are implemented to revolve along concentric revolution paths, the monitoring directions of the plurality of camera modules provided in the multi-camera can be finely adjusted, and thus user convenience can be improved.

Meanwhile, according to an additional aspect of the invention, the cylindrical inner guide 130 may include a first restriction protrusion 131. The first restriction protrusion 131 protrudes along an outer circumferential portion of the cylindrical inner guide 130 and is in close contact with and supports an upper portion of the inner revolution protrusion 113 of each of the plurality of camera support brackets 110 which are in close contact with and are supported by the outer circumferential portion of the cylindrical inner guide 130 to restrict the camera support brackets 110 from being vertically separated.

Referring to FIG. 2, it can be seen that the first restriction protrusion 131 is formed to protrude along the outer circumferential portion of the cylindrical inner guide 130 and is in close contact with and supports the upper portion of the inner revolution protrusion 113 of each of the plurality of camera support brackets 110 which are in close contact with and are supported by the outer circumferential portion of the cylindrical inner guide 130 to restrict the camera support brackets 110 from being vertically separated.

In the present invention with this implementation, when the camera support brackets 110 to which the camera modules 200 are fixed to be tiltable are mounted on the circular camera support bracket mounting plate 120 and implemented to revolve, the vertical separation of the camera support brackets 110 are restricted by the first restriction protrusion 131, and thus stable operation can be performed when the monitoring directions of the camera modules are finely adjusted.

Meanwhile, according to an additional aspect of the invention, the multi-camera support apparatus 100 that easily adjusts spacing between the camera modules may further include an O-ring 150. The O-ring 150 is mounted on the inner revolution path 121 and assists inner revolution of each of the camera support brackets 110 under the inner revolution protrusion 113 seated on the inner revolution path 121.

In this case, the O-ring 150 may be implemented such that revolution sensitivity is adjusted by a change in amount of pressing through vertical spacing adjustment of the first restriction protrusion 131 which is in close contact with and supports the upper portion of the inner revolution protrusion 113 of each of the camera support brackets 110. Meanwhile, the O-ring 150 may be implemented to be coated with urethan for improving the revolution sensitivity.

Referring to FIG. 2, it can be seen that the O-ring 150 is mounted under the inner revolution protrusion 113 seated on the inner revolution path 121 and assists the inner revolution of each of the camera support brackets 110.

In addition, it can be seen that, when the cylindrical inner guide 130 is mounted in a central portion of the circular camera support bracket mounting plate 120 by screw coupling, vertical spacing adjustment of the first restriction protrusion 131 is possible by adjusting a screw fastening extend, and adjustment of the revolution sensitivity (a difficulty in operating revolution due to friction) is possible by adjusting a friction degree between the inner revolution protrusion 113 and the O-ring 150.

In the present invention with this implementation, when the camera support bracket 110, to which the camera module 200 is fixed to be tiltable, is implemented to be mounted on the circular camera support bracket mounting plate 120 to revolve, the inner revolution of each of the camera support brackets 110 may be assisted, and the revolution sensitivity may be adjusted at the same time through the O-ring 150 mounted under the inner revolution protrusion 113.

Meanwhile, according to an additional aspect of the invention, the ring-shaped outer guide 140 may include a second restriction protrusion 141. The second restriction protrusion 141 protrudes along an inner circumferential portion of the ring-shaped outer guide 140 and is in close contact with and supports an upper portion of an outer circumferential portion of the outer revolution protrusion 114 of each of the plurality of camera support brackets 110 which are in close contact with and are supported by the inner circumferential portion of the ring-shaped outer guide 140 to restrict the camera support brackets 110 from being vertically separated.

Referring to FIG. 2, it can be seen that the second restriction protrusion 141 protrudes along the inner circumferential portion of the ring-shaped outer guide 140 and is in close contact with and supports the upper portion of the outer circumferential portion of the outer revolution protrusion 114 of each of the plurality of camera support brackets 110 which are in close contact with and are supported by the inner circumferential portion of the ring-shaped outer guide 140 to restrict the camera support brackets 110 from being vertically separated.

In the present invention with this implementation, when the camera support brackets 110, to which the camera modules 200 are fixed to be tiltable, are implemented to be mounted on the circular camera support bracket mounting plate 120 to revolve, the vertical separation of the camera support brackets 110 are restricted by the second restriction protrusion 141, and thus the stable operation is possible when the monitoring directions of the camera modules are finely adjusted.

Meanwhile, according to an additional aspect of the invention, the multi-camera support apparatus 100 that easily adjusts spacing between the camera modules may further include a plurality of tension balls 160. The plurality of tension balls 160 are mounted on the outer revolution path 122 and assist the camera support brackets 110 at both sides of the outer revolution protrusion 114 seated on the outer revolution path 122 and provide an elastic force at the same time.

In this case, the bracket body 111 may include tension ball accommodation parts 111a which are formed to be recessed in a bottom surface to be spaced apart from both sides of the outer revolution protrusion 114 extending and protruding downward from the central portion and accommodate the tension balls 160, and the tension balls 160 may be implemented to be fixed in a cantilever type in the tension ball accommodation parts 111a.

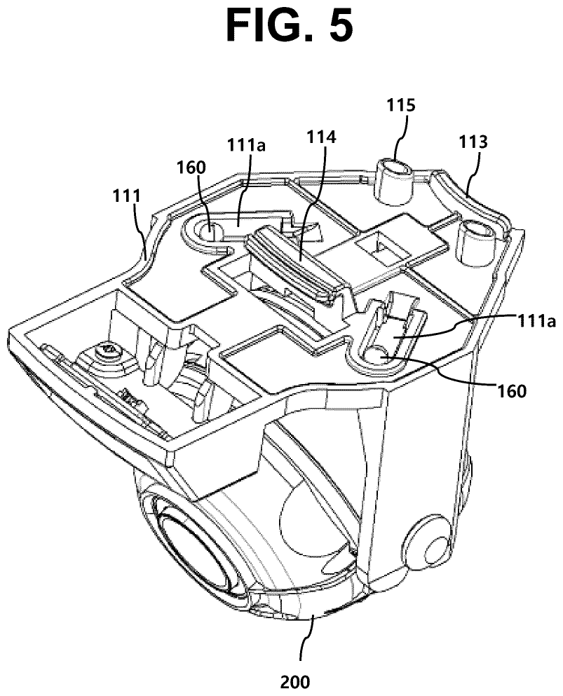

FIG. 5 is a bottom perspective view illustrating the camera support bracket of the multi-camera support apparatus that easily adjusts spacing between camera modules according to one embodiment of the present invention.

Referring to FIG. 5, it can be seen that the outer revolution protrusion 114 is formed to extend and protrude downward from the central portion of the bracket body 111, a pair of tension ball accommodation parts 111a are formed at both sides of the bottom surface of the bracket body 111 from which the outer revolution protrusion 114 extends and protrudes, and each of the tension balls 160 is accommodated and mounted in one of the pair of the tension ball accommodation parts 111a.

The tension ball 160 accommodated in the tension ball accommodation part 111a is mounted on the outer revolution path 122, assists outer revolution of each of the camera support brackets 110 while rotating when the outer revolution protrusion 114 revolves along the outer revolution path 122, and provides the elastic force for preventing mechanical separation.

In the present invention with this implementation, when the camera support bracket 110, to which the camera module 200 is fixed to be tiltable, is implemented to be mounted on the circular camera support bracket mounting plate 120 to revolve, the outer revolution of each of the camera support brackets 110 can be assisted by the tension balls 160 mounted at both sides of the outer revolution protrusion 114, and the elastic force can be provided at the same time.

In addition, in the present invention, since mechanical separation can be prevented through mutual interactions between the cylindrical inner guide 130, the ring-shaped outer guide 140, the first restriction protrusion 131, the second restriction protrusion 141, the O-ring 150, and the tension balls 160 when the camera support bracket 110 revolves, the stable operation is possible when the monitoring directions of the camera modules are finely adjusted.

Meanwhile, according to an additional aspect of the invention, the multi-camera support apparatus 100 that easily adjusts spacing between camera modules may further include a plurality of light-emitting diodes (LEDs) 170. Each of the plurality of LEDs 170 is installed on an outer circumferential portion of the bracket body 111 of one of the camera support brackets 110 and emits light in the monitoring direction.

In the present invention with this implementation, stable monitoring image capturing can be assisted by the plurality of LEDs 170 each installed on the outer circumferential portion of the bracket body 111 of each of the camera support brackets 110 by emitting the light in the monitoring direction even during dark weather or at night.

Meanwhile, according to an additional aspect of the invention, the multi-camera support apparatus 100 that easily adjusts spacing between camera modules may further include a base 180 which fixedly supports the camera support bracket mounting plate 120.

Referring to FIGS. 1 and 2, it can be seen that a rear surface of the camera support bracket mounting plate 120 is screw-coupled to a front surface of the base 180 so that the camera support bracket mounting plate 120 is supported by the base 180.

Meanwhile, according to an additional aspect of the invention, the multi-camera support apparatus 100 that easily adjusts spacing between camera modules may further include a dome cover 190. The dome cover 190 is formed of a transparent material so as not to hinder visibility of the camera modules 200 and coupled to a front surface of the camera support bracket mounting plate 120 by a screw-coupling method or the like to protect the camera modules 200 therein.

In this case, since the dome cover 190 may be implemented in a donut shape such that distances between an inner side of the dome cover 190 and lenses of the camera modules are always constant regardless of tilt angles of the camera modules 200 supported by the camera support brackets 110 to be tiltable, a shooting error cannot occur.

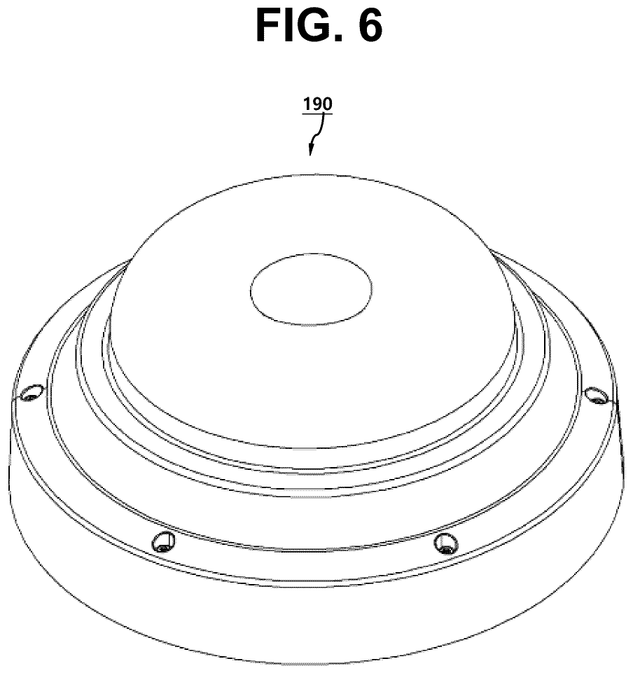

FIG. 6 is a perspective view illustrating the dome cover of the multi-camera support apparatus that easily adjusts spacing between camera modules according to one embodiment of the present invention. Referring to FIG. 6, it can be seen that the dome cover 190, of which a central portion is implemented in a donut shape, is couple to the front surface of the camera support bracket mounting plate 120 to protect the camera modules 200 therein.

In the present invention described above, since the plurality of camera modules are implemented to revolve along the concentric revolution paths, the monitoring directions of the plurality of camera modules provided in the multi-camera can be easily, simply, and finely adjusted, and thus user convenience can be improved.

The various embodiments disclosed in the present specification and drawings are only specific examples to aid in understanding of the invention and are not intended to limit various embodiments of the present invention.

Accordingly, the scope of various embodiments of the present invention should not be limited by the above-described embodiments, and all changes or modifications derived from the technical ideas of various embodiments of the present invention should be construed as being included in the scope of various embodiments of the present invention.

### INDUSTRIAL APPLICABILITY

The present invention can be industrially used in technical fields related to a multi-camera in which a plurality of camera modules are mounted and applications thereof.

What is claimed is:

1. A multi-camera support apparatus that easily adjusts spacing between camera modules, the multi-camera support apparatus comprising:
a plurality of camera support brackets which support a plurality of camera modules to be tiltable and each includes a bracket body, camera module fixing parts which vertically extend upward from both sides of the bracket body and fix the camera module to be tiltable, an inner revolution protrusion extending and protruding downward from an inner circumferential portion of the bracket body, and an outer revolution protrusion extending and protruding downward from a central portion of the bracket body;
a circular camera support bracket mounting plate which includes an inner revolution path on which the inner revolution protrusion is seated and an outer revolution path on which the outer revolution protrusion is seated, wherein the plurality of camera support brackets are mounted to individually revolve along the inner revolution path and the outer revolution path, which are concentric paths, to allow spacing between the camera modules supported by the camera support brackets to be adjusted;
a cylindrical inner guide which is vertically mounted at a central portion of the circular camera support bracket mounting plate and guides revolution while in close contact with and supporting the inner revolution protrusion of each of the plurality of camera support brackets; and
a ring-shaped outer guide which is mounted on the outer revolution path and guides revolution while in contact with and supporting the outer revolution protrusion of each of the plurality of camera support brackets.

2. The multi-camera support apparatus of claim 1, wherein the cylindrical inner guide includes a first restriction protrusion which protrudes along an outer circumferential portion of the cylindrical inner guide and is in close contact with and supports an upper portion of the inner revolution protrusion of each of the plurality of camera support brackets which are in close contact with and are supported by the outer circumferential portion to restrict the camera support brackets from being vertically separated.

3. The multi-camera support apparatus of claim 2, further comprising an O-ring which is mounted on the inner revolution path and assists inner revolution of each of the camera support brackets under the inner revolution protrusion seated on the inner revolution path.

4. The multi-camera support apparatus of claim 3, wherein the O-ring adjusts revolution sensitivity due to a change in amount of pressing through vertical spacing adjustment of the first restriction protrusion which is in close contact with and supports the upper portion of the inner revolution protrusion of each of the camera support brackets.

5. The multi-camera support apparatus of claim 4, wherein the O-ring is coated with urethan to improve the revolution sensitivity.

6. The multi-camera support apparatus of claim 1, wherein the ring-shaped outer guide includes a second restriction protrusion which protrudes along an inner circumferential portion of the ring-shaped outer guide and is in close contact with and supports an upper portion of an outer circumferential portion of the outer revolution protrusion of each of the plurality of camera support brackets which are in contact with and are supported by the inner circumferential portion to restrict the camera support brackets from being vertically separated.

7. The multi-camera support apparatus of any one of claim 1, further comprising a plurality of tension balls which are mounted on the outer revolution path, assist outer revolution of each of the camera support brackets at both sides of the outer revolution protrusion seated on the outer revolution path, and provide an elastic force at the same time.

8. The multi-camera support apparatus of claim 7, wherein the bracket body includes tension ball accommodation parts which are formed to be recessed in a bottom surface of the bracket body to be spaced apart from both sides of the outer revolution protrusion extending and protruding downward from the central portion and accommodate the tension balls.
